(19) United States
(12) Patent Application Publication
(10) Pub. No.: US 2016/0237197 A1
(43) Pub. Date: Aug. 18, 2016

(54) THERMOPLASTIC POLYURETHANES MADE WITH TIN-FREE CATALYSTS

(71) Applicant: Lubrizol Advanced Materials, Inc., Cleveland, OH (US)

(72) Inventors: Marie-Anne Persoons, Aartselaar (BE); Jacques P.E.J. Horrion, Tilff (BE); Dirk De Vos, Holsbeek (BE); Yves Schellekens, Vosselaar (BE)

(73) Assignee: Lubrizol Advanced Materials, Inc., Cleveland, OH (US)

(21) Appl. No.: 15/028,084

(22) PCT Filed: Oct. 10, 2014
(86) PCT No.: PCT/US14/60012

§ 371 Date: Apr. 8, 2016

Related U.S. Application Data
(60) Provisional application No. 61/890,899, filed on Oct. 15, 2013.

(51) Int. Cl. C08G 18/22; C08G 18/75

(52) U.S. Cl. CPC C08G 18/222; C08G 18/758

(57) ABSTRACT

Thermoplastic polyurethanes, including those based on aliphatic isocyanates, are of great interest for industrial applications that require UV-stability. To overcome the low reactivity of some diisocyanates a catalyst is usually added to accelerate urethane formation. In most applications, organotin-based compounds are used, however, due to growing concerns about the toxicity of some of these organotin compounds, their use is being restricted and the need for alternative catalysts is growing. The thermoplastic polyurethanes described herein are made using tin-free catalysts while retaining the UV-stability and other properties required for many industrial applications.

### FIELD OF THE INVENTION

Thermoplastic polyurethanes (TPU), including those based on aliphatic isocyanates, are of great interest for industrial applications that require UV-stability. To overcome the low reactivity of some diisocyanates, a catalyst is usually added to accelerate urethane formation. In most applications, organotin-based compounds are used, however, due to growing concerns about the toxicity of some of these organotin compounds, their use is being restricted and the need for alternative catalysts is growing. The thermoplastic polyurethanes described herein are made using tin-free catalysts while retaining the UV-stability required for many industrial applications.

### BACKGROUND OF THE INVENTION

The disclosed technology relates to thermoplastic polyurethanes and compositions thereof made using tin-free catalysts while still retaining the physical properties required for many industrial applications and which are typically associated with thermoplastic polyurethanes and compositions thereof made using organotin catalysts.

Ever since their discovery by Otto Bayer in the 1930s, polyurethanes have gained increasing interest by industry due to the wide array of products that can be made from them, ranging from soft foams for automotive and building applications to hard wear-resistant materials used in sports articles and industrial applications. The versatility of TPU can be attributed to the large number of monomers available, which in turn results in products with different physical and chemical properties.

The main reaction taking place during TPU formation is the polyaddition of alcohols and isocyanates. To accelerate this reaction, one or more catalysts may be added, depending on the desired end product. Usually, TPU catalysts are subdivided into two main categories: metal-based catalysts, typically accelerating the reaction between isocyanate and alcohol, and (tertiary) amine-based catalysts, mostly used in foaming reactions as these catalysts also promote the isocyanate-water reaction. The technology disclosed herein is focused on metal-based catalysts.

The most popular type of metal-based catalysts for TPU reactions are organo-tin catalysts. These catalysts provide very short reaction times for the isocyanate-hydroxyl reaction when used under typical industrial processing conditions. A broad range of organotin catalysts are available, allowing the chemist to select the optimal catalyst for each application. However, due to the high stability of the covalent alkyl-tin bond against hydrolysis and both thermal and oxidative degradation, organotin compounds may end up in the environment. Their toxicity depends on several factors, the number of alkyl groups on Sn being the most important one. Both di- and in particular tri-substituted compounds display the highest toxicity. Apart from the degree of alkyl substitution, the toxicity also depends on the length of the alkyl side chain, with increasing toxicity for shorter side chains. As a consequence, research efforts are being conducted towards finding alternative catalysts for the urethane formation.

Various alternatives to organotin catalysts have been considered as researchers have tried to avoid the toxicity issues described above. However, these alternatives generally suffer from poor reactivity at low concentrations and/or low reaction temperatures. Due to the nature of TPU processing, a catalyst with good reactivity at low concentrations and mild reaction temperatures, that will not degrade the TPU or components used to make the same, is sorely needed.

The present technology deals with TPU made from tin-free catalysts that avoid the toxicity issues associated with organotin catalysts while still providing high performing TPU.

### SUMMARY OF THE INVENTION

The disclosed technology provides a thermoplastic polyurethane composition including the reaction product of: a) a polyisocyanate; b) a polyol component; and c) a chain extender component; where the reaction is carried out in the presence of a catalyst and where said catalyst includes one or more iron compounds. In some embodiments, the catalyst is an iron (III) compound, or another compound such as an iron (II) compound that can be converted to an iron (III) compound in the reaction mixture.

The technology provides the described thermoplastic polyurethane compositions wherein the catalyst is free of tin.

The technology provides the described thermoplastic polyurethane compositions wherein the catalyst includes a compound having the general structure (X)ₘ-M-(Y)ₙ where m is 2 or 3, M is iron; each X is independently a ligand with a −1 charge; each Y is a neutral ligand; and n is an integer between 0 and 6.

The ligand X may be obtained by deprotonation of a β-diketone compound, a β-ketoester compound, a β-ketoamide compound or any other β-dicarbonyl compound, chloride, bromide, iodide, fluoride, perchlorate, alkoxide, alkylsulfonate, arylsulfonate, alkylsulfate, arylsulfate, hydroxide, or a combination of these ligands. The neutral ligand Y may be obtained from water, an alcohol, an α-diimine compound, or any combination thereof.

The technology provides the described thermoplastic polyurethane compositions wherein the catalyst includes a compound of Fe(III) or Fe(II) containing three or two anionic ligands, each formed by deprotonation of a β-diketone, a β-ketoester, a β-ketoamide, or a combination thereof.

The technology provides the described thermoplastic polyurethane compositions wherein the catalyst includes a compound of Fe(III) or Fe(II) containing three or two halide counteranions each derived from chloride, fluoride, bromide, iodide, a compound resulting from the partial alcoholysis or hydrolysis of any of these compounds, or a combination thereof.

The technology provides the described thermoplastic polyurethane compositions wherein the catalyst includes a compound of Fe(III) or Fe(II) containing one, two or three α-diimine ligands each derived from 2,2′-bipyridine, 1,10-phenanthroline, substituted variants of 2,2′-bipyridine or 1,10-phenanthroline, or some combination thereof.

The technology provides the described thermoplastic polyurethane compositions wherein the catalyst includes iron(III)-tris-2,4-pentanedionate, iron(III)-tris-(1,1,1-trifluoro-2,4-pentanedionate), iron(III)-tris-(1,1,1,5,5,5-hexafluoro-2,4-pentanedionate), iron (III)-tris-(2,2,6,6-tetramethyl-3,5-heptanedionate), iron(III)-tris-(6-methyl-2,4-heptanedionate); iron (III) chloride, iron(II)chloride, iron(III)bromide; iron(III)-tris(2,2′-bipyridine) trichloride, iron(III)-tris(1,10-phenanthroline) trichloride, or combinations thereof.

The technology provides the described thermoplastic polyurethane compositions wherein the polyisocyanate includes an aromatic diisocyanate, an aliphatic diisocyanate, or a combination thereof.

The technology provides the described thermoplastic polyurethane compositions wherein the polyisocyanate is at least 50%, on a weight basis, a cycloaliphatic diisocyanate.

The technology provides the described thermoplastic polyurethane compositions wherein the polyisocyanate includes hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, or combinations thereof.

The technology provides the described thermoplastic polyurethane compositions wherein the polyol component includes a polyether polyol.

The technology provides the described thermoplastic polyurethane compositions wherein the polyol component includes ethylene oxide, propylene oxide, butylene oxide, styrene oxide, poly(tetramethylene ether glycol), poly(propylene glycol), poly(ethylene glycol), copolymers of poly(ethylene glycol) and poly(propylene glycol), epichlorohydrin, and the like, or combinations thereof.

The technology provides the described thermoplastic polyurethane compositions wherein the chain extender component includes diols, diamines, or combinations thereof.

The technology provides the described thermoplastic polyurethane compositions wherein the chain extender component includes 1,4-butanediol, 2-ethyl-1,3-hexanediol, 2,2,4-trimethylpentane-1,3-diol, 1,6-hexanediol, 1,4-cyclohexane dimethylol, 1,3-propanediol, 3-methyl-1,5-pentanediol, ethylene glycol (also known as 1,2-ethanediol), or combinations thereof.

The technology provides the described thermoplastic polyurethane compositions wherein the polyisocyanate includes 4,4′-methylene bis(cyclohexylisocyanate), which may also be referred as di-cyclohexyl diisocyanate and/or H12MDI, the polyol component includes poly(tetramethylene ether glycol), the chain extender component includes 1,4-butanediol, and the catalyst includes iron (III) chloride.

The technology further provides a process of preparing the described thermoplastic polyurethane compositions. The process includes the step of (I) reacting: a) a polyisocyanate; b) a polyol component; and c) a chain extender component; where the reaction is carried out in the presence of a catalyst, where said catalyst includes one or more iron compounds, resulting in a thermoplastic polyurethane composition.

The technology further provides an article that includes and/or is made from any of the thermoplastic polyurethane compositions described herein.

The technology further provides a method of maintaining the ultraviolet stability of a thermoplastic polyurethane composition while reducing the toxicity of the thermoplastic polyurethane composition, where the method includes the steps of: (I) reacting: a) a polyisocyanate; b) a polyol component; and c) a chain extender component; where the reaction is carried out in the presence of a catalyst, where said catalyst includes one or more iron compounds; resulting in a thermoplastic polyurethane composition with ultraviolet stability and reduced toxicity compared to a similar thermoplastic polyurethane composition made using a tin containing catalyst.

### DETAILED DESCRIPTION OF THE INVENTION

Various preferred features and embodiments will be described below by way of non-limiting illustration.

The disclosed technology provides thermoplastic polyurethane (TPU) compositions that include the reaction product of: a) a polyisocyanate; b) a polyol component; and c) a chain extender component; where the reaction is carried out in the presence of a catalyst, and where the catalyst comprises one or more iron compound. In some embodiments, the catalyst is free of any tin containing compounds and/or is completely free of tin.

### The Polyisocyanate

The TPU compositions described herein are made using a) a polyisocyanate component. The polyisocyanate and/or polyisocyanate component includes one or more polyisocyanates. In some embodiments, the polyisocyanate component includes one or more diisocyanates.

In some embodiments, the polyisocyanate and/or polyisocyanate component includes an alpha, omega-alkylene diisocyanate having from 5 to 20 carbon atoms.

Suitable polyisocyanates include aromatic diisocyanates, aliphatic diisocyanates, or combinations thereof. In some embodiments, the polyisocyanate component includes one or more aromatic diisocyanates. In some embodiments, the polyisocyanate component is essentially free of, or even completely free of, aliphatic diisocyanates. In other embodiments, the polyisocyanate component includes one or more aliphatic diisocyanates. In some embodiments, the polyisocyanate component is essentially free of, or even completely free of, aromatic diisocyanates.

Examples of useful polyisocyanates include aromatic diisocyanates such as 4,4′-methylenebis(phenyl isocyanate) (MDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), 3,3′-dimethyl-4,4′-biphenylene diisocyanate (TODI), 1,5-naphthalene diisocyanate (NDI), and dicyclohexylmethane-4,4′-diisocyanate (H12MDI). Mixtures of two or more polyisocyanates may be used. In some embodiments, the polyisocyanate is MDI and/or H12MDI. In some embodiments, the polyisocyanate includes MDI. In some embodiments, the polyisocyanate includes H12MDI.

In some embodiments, the thermoplastic polyurethane is prepared with a polyisocyanate component that includes H12MDI. In some embodiments, the thermoplastic polyurethane is prepared with a polyisocyanate component that consists essentially of H12MDI. In some embodiments, the thermoplastic polyurethane is prepared with a polyisocyanate component that consists of H12MDI.

In some embodiments, the thermoplastic polyurethane is prepared with a polyisocyanate component that includes (or consists essentially of, or even consists of) H12MDI and at least one of MDI, HDI, TDI, IPDI, LDI, BDI, PDI, CHDI, TODI, and NDI.

In some embodiments, the polyisocyanate used to prepare the TPU and/or TPU compositions described herein is at least 50%, on a weight basis, a cycloaliphatic diisocyanate. In some embodiments, the polyisocyanate includes an alpha, omega-alkylene diisocyanate having from 5 to 20 carbon atoms.

In some embodiments, the polyisocyanate used to prepare the TPU and/or TPU compositions described herein includes hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, or combinations thereof.

### The Polyol Component

The TPU compositions described herein are made using b) a polyol component. Polyols include polyether polyols, polyester polyols, polycarbonate polyols, polysiloxane polyols, and combinations thereof.

Suitable polyols, which may also be described as hydroxyl terminated intermediates, when present, may include one or more hydroxyl terminated polyesters, one or more hydroxyl terminated polyethers, one or more hydroxyl terminated polycarbonates, one or more hydroxyl terminated polysiloxanes, or mixtures thereof.

Suitable hydroxyl terminated polyester intermediates include linear polyesters having a number average molecular weight (Mn) of from about 500 to about 10,000, from about 700 to about 5,000, or from about 700 to about 4,000, and generally have an acid number less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2202A, a 2000 number average molecular weight (Mn) linear polyester diol, and CAPA™ 2302A, a 3000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3000.

Suitable hydroxyl terminated polyether intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as Poly THF B, a block copolymer, and poly THF R, a random copolymer. The various polyether intermediates generally have a number average molecular weight (Mn) as determined by assay of the terminal functional groups which is an average molecular weight greater than about 700, such as from about 700 to about 10,000, from about 1000 to about 5000, or from about 1000 to about 2500. In some embodiments, the polyether intermediate includes a blend of two or more different molecular weight polyethers, such as a blend of 2000 Mₙ and 1000 Mₙ PTMEG.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-L5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5000, or from 400 to 3000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

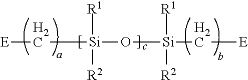

in which: each R¹ and R² are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each independently an integer from 2 to 8; c is an integer from 3 to 50. In amino-containing polysiloxanes, at least one of the E groups is NHR³. In the hydroxyl-containing polysiloxanes, at least one of the E groups is OH. In some embodiments, both R¹ and R² are methyl groups.

Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with a poly(alkylene oxide).

The polyol component, when present, may include poly(ethylene glycol), poly(tetramethylene ether glycol), poly(trimethylene oxide), ethylene oxide capped poly(propylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

Examples of dimer fatty acids that may be used to prepare suitable polyester polyols include Priplast™ polyester glycols/polyols commercially available from Croda and Radia® polyester glycols commercially available from Oleon.

In some embodiments, the polyol component includes a polyether polyol, a polycarbonate polyol, a polycaprolactone polyol, or any combination thereof.

In some embodiments, the polyol component includes a polyether polyol. In some embodiments, the polyol component is essentially free of or even completely free of polyester polyols. In some embodiments, the polyol component used to prepare the TPU is substantially free of, or even completely free of polysiloxanes.

In some embodiments, the polyol component includes ethylene oxide, propylene oxide, butylene oxide, styrene oxide, poly(tetramethylene ether glycol), poly(propylene glycol), poly(ethylene glycol), copolymers of poly(ethylene glycol) and poly(propylene glycol), epichlorohydrin, and the like, or combinations thereof. In some embodiments, the polyol component includes poly(tetramethylene ether glycol).

### The Chain Extender Component

The TPU compositions described herein are made using c) a chain extender component. Chain extenders include diols, diamines, and combination thereof.

Suitable chain extenders include relatively small polyhydroxy compounds, for example, lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyl]propane (HEPP), hexamethylenediol, heptanediol, nonanediol, dodecanediol, 3-methyl-L5-pentanediol, ethylenediamine, butanediamine, hexamethylenediamine, and hydroxyethyl resorcinol (HER), and the like, as well as mixtures thereof. In some embodiments, the chain extender includes BDO, HDO, 3-methyl-1,5-pentanediol, or a combination thereof. In some embodiments, the chain extender includes BDO. Other glycols, such as aromatic glycols could be used, but in some embodiments, the TPUs described herein are essentially free of or even completely free of such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example HEPP, HER, or a combination thereof. In some embodiments, the chain extender used to prepare the TPU includes an aliphatic cyclic chain extender, for example, CHDM. In some embodiments, the chain extender used to prepare the TPU is substantially free of, or even completely free of aromatic chain extenders, for example, aromatic cyclic chain extenders. In some embodiments, the chain extender used to prepare the TPU is substantially free of, or even completely free of polysiloxanes.

In some embodiments, the chain extender component includes 1,4-butanediol, 2-ethyl-1,3-hexanediol, 2,2,4-trimethyl pentane-1,3-diol, 1,6-hexanediol, 1,4-cyclohexane dimethylol, 1,3-propanediol, 3-methyl-1,5-pentanediol or combinations thereof. In some embodiments, the chain extender component includes 1,4-butanediol, 3-methyl-1,5-pentanediol or combinations thereof. In some embodiments, the chain extender component includes 1,4-butanediol.

### The Catalyst

The TPU compositions described herein are prepared using a catalyst that includes one or more iron (III) compounds. That is the reaction between the polyisocyanate, polyol, and chain extender components described above is carried out in the presence of a catalyst, where the catalyst includes one or more iron (III) compounds.

It is noted that iron (II) compounds may readily convert to iron (III) compounds, and so both are included within the scope of the described technology to the extent that the reaction may be catalyzed by one or more iron (III) compounds.

The iron (III) compounds useful in the described technology contain ligands. The term ligand, as used herein, means an ion, molecule, and/or functional group that binds to a metal atom to form a coordination complex. The bonding between the metal and the ligand generally involves formal donation of one or more of the ligand's electron pairs. The metal-ligand bonding can range from covalent to ionic.

Suitable ligands for the catalysts described herein include: (i) ligands formed by deprotonation of a β-diketone, a β-ketoester, a β-ketoamide, or a combination thereof; (ii) halide counteranion ligands each derived from chloride, fluoride, bromide, iodide, a compound resulting from the partial alcoholysis or hydrolysis of any of these iron-halide compounds, or a combination thereof; (iii) α-diimine ligands each derived from 2,2′-bipyridine, 1,10-phenanthroline, substituted variants of 2,2′-bipyridine or 1,10-phenanthroline, or some combination thereof; or (iv) any combination thereof. In some embodiments, the ligands are not mixed (all ligands in the catalyst are the same).

In some embodiments, the ligands of the catalyst are derived from 2,4-pentanedionate, 1,1,1-trifluoro-2,4-pentanedionate, 1,1,1,5,5,5-hexafluoro-2,4-pentanedionate, 2,2,6,6-tetramethyl-3,5-heptanedionate, 6-methyl-2,4-heptanedionate, chloride, 2,2′-bipyridine, chloride, or combinations thereof.

The catalyst may include a compound having the general structure (X)ₘ-M-(Y)ₙ where m is 2 or 3, M is iron, each X is independently a ligand with a −1 charge, each Y is a neutral ligand, and n is an integer between 0 and 6. The ligands of X may be obtained by deprotonation of a β-diketone compound, a β-ketoester compound, a β-ketoamide compound or any other β-dicarbonyl compound, chloride, bromide, iodide, fluoride, perchlorate, alkoxide, alkylsulfonate, arylsulfonate, alkylsulfate, arylsulfate, hydroxide. The neutral ligand, Y, is a ligand that does not have a −1 charge. Suitable examples of neutral ligands include ligands derived from water, alcohol, or an α-diimine compound.

In some embodiments, n is 0 and no neutral ligand, Y, is present. In such embodiments, the catalyst may include a compound having the general structure (X)ₘ-M where m is 2 or 3, M is iron, and each X is independently a ligand with a −1 charge. It is noted that M may be iron (II) or iron (III). In some embodiments, M is iron (III).

In some embodiments, the catalyst includes a compound of Fe(III) or Fe(II) containing three to two anionic ligands, each formed by deprotonation of a β-diketone, a β-ketoester, a β-ketoamide, or a combination thereof.

In some embodiments, the catalyst includes a compound of Fe(III) or Fe(II) containing three or two halide counteranions each derived from chloride, fluoride, bromide, iodide, a compound resulting from the partial alcoholysis or hydrolysis of any of these compounds, or a combination thereof.

In some embodiments, the catalyst includes a compound of Fe(III) or Fe(II) containing one, two or three α-diimine ligands each derived from 2,2′-bipyridine, 1,10-phenanthroline, substituted variants of 2,2′-bipyridine or 1,10-phenanthroline, or some combination thereof.

In some embodiments, the catalyst includes iron(III)-tris-(2,4-pentanedionate), iron(III)-tris-(1,1,1-trifluoro-2,4-pentanedionate), iron(III)-tris-(1,1,1,5,5,5-hexafluoro-2,4-pentanedionate), iron (III)-tris-(2,2,6,6-tetramethyl-3,5-heptanedionate), iron(III)-tris-(6-methyl-2,4-heptanedionate); iron(III)chloride, iron(II)chloride, iron(III)bromide; iron(III)-tris(2,2′-bipyridine) trichloride, iron(III)-tris(1,10-phenanthroline) trichloride, or combinations thereof.

In some embodiments, the catalyst includes iron chloride.

In some embodiments, the TPU is prepared by the described reaction where the polyisocyanate includes 4,4′-methylene bis(cyclohexylisocyanate); the polyol component includes poly(tetramethylene ether glycol); and the chain extender component includes 1,4-butanediol.

In some embodiments, the TPU is prepared by the described reaction where the catalyst includes Fe(acetylacetonate)₃, Fe(2,2,6,6-tetramethyl-3,5-heptanedionate)₃, FeCl₃, Fe(trifluoromethanesulfonate)₃, or any combination thereof.

In some embodiments, the TPU is prepared by the described reaction where the catalyst includes Fe(acetylacetonate)₃, Fe(2,2,6,6-tetramethyl-3,5-heptanedionate)₃, FeCl₃, or any combination thereof.

In some embodiments, the TPU is prepared by the described reaction where the catalyst includes Fe(acetylacetonate)₃. In some embodiments, the TPU is prepared by the described reaction where the catalyst includes Fe(2,2,6,6-tetramethyl-3,5-heptanedionate)₃. In some embodiments, the TPU is prepared by the described reaction where the catalyst includes FeCl₃. In some embodiments, the TPU is prepared by the described reaction where the catalyst includes Fe(trifluoromethanesulfonate)₃.

In some embodiments, the TPU is prepared by the described reaction where the polyisocyanate includes 4,4′-methylene-bis(cyclohexyl isocyanate); the polyol component includes poly(tetramethylene ether glycol); the chain extender component includes 1,4-butanediol; and the catalyst includes iron (III) chloride.

### The Thermoplastic Polyurethane Compositions

The compositions described herein are TPU compositions. They contain one or more TPU. These TPU are prepared by reacting: a) the polyisocyanate component described above; b) the polyol component described above; and c) the chain extender component described above, where the reaction is carried out in the presence of a catalyst and where said catalyst comprises one or more of the iron compounds described above.

The means by which the reaction is carried out is not overly limited, and includes both batch and continuous processing. In some embodiments, the technology deals with batch processing of aliphatic TPU. In some embodiments, the technology deals with continuous processing of aliphatic TPU.

The described compositions include the TPU materials described above and also TPU compositions that include such TPU materials and one or more additional components. These additional components include other polymeric materials that may be blended with the TPU described herein. These additional components include one or more additives that may be added to the TPU, or blend containing the TPU, to impact the properties of the composition.

The TPU described herein may also be blended with one or more other polymers. The polymers with which the TPU described herein may be blended are not overly limited. In some embodiments, the described compositions include two or more of the described TPU materials. In some embodiments, the compositions include at least one of the described TPU materials and at least one other polymer, which is not one of the described TPU materials.

Polymers that may be used in combination with the TPU materials described herein also include more conventional TPU materials such as non-caprolactone polyester-based TPU, polyether-based TPU, or TPU containing both non-caprolactone polyester and polyether groups. Other suitable materials that may be blended with the TPU materials described herein include polycarbonates, polyolefins, styrenic polymers, acrylic polymers, polyoxymethylene polymers, polyamides, polyphenylene oxides, polyphenylene sulfides, polyvinylchlorides, chlorinated polyvinylchlorides, polylactic acids, or combinations thereof.

Polymers for use in the blends described herein include homopolymers and copolymers. Suitable examples include: (i) a polyolefin (PO), such as polyethylene (PE), polypropylene (PP), polybutene, ethylene propylene rubber (EPR), polyoxyethylene (POE), cyclic olefin copolymer (COC), or combinations thereof; (ii) a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; (iii) a thermoplastic polyurethane (TPU) other than those described above; (iv) a polyamide, such as Nylon™, including polyamide 6,6 (PA66), polyamide 1,1 (PA11), polyamide 1,2 (PA12), a copolyamide (COPA), or combinations thereof; (v) an acrylic polymer, such as polymethyl acrylate, polymethylmethacrylate, a methyl methacrylate styrene (MS) copolymer, or combinations thereof; (vi) a polyvinylchloride (PVC), a chlorinated polyvinylchloride (CPVC), or combinations thereof; (vii) a polyoxyemethylene, such as polyacetal; (viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; (ix) a polycarbonate (PC), a polyphenylene sulfide (PPS), a polyphenylene oxide (PPO), or combinations thereof; or combinations thereof.

In some embodiments, these blends include one or more additional polymeric materials selected from groups (i), (iii), (vii), (viii), or some combination thereof. In some embodiments, these blends include one or more additional polymeric materials selected from group (i). In some embodiments, these blends include one or more additional polymeric materials selected from group (iii). In some embodiments, these blends include one or more additional polymeric materials selected from group (vii). In some embodiments, these blends include one or more additional polymeric materials selected from group (viii).

The additional additives suitable for use in the TPU compositions described herein are not overly limited. Suitable additives include pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, antimicrobials, and any combination thereof.

In some embodiments, the additional component is a flame retardant. Suitable flame retardants are not overly limited and may include a boron phosphate flame retardant, a magnesium oxide, a dipentaerythritol, a polytetrafluoroethylene (PTFE) polymer, or any combination thereof. In some embodiments, this flame retardant may include a boron phosphate flame retardant, a magnesium oxide, a dipentaerythritol, or any combination thereof. A suitable example of a boron phosphate flame retardant is BUDIT 326, commercially available from Budenheim USA, Inc. When present, the flame retardant component may be present in an amount from 0 to 10 weight percent of the overall TPU composition, in other embodiments from 0.5 to 10, or from 1 to 10, or from 0.5 or 1 to 5, or from 0.5 to 3, or even from 1 to 3 weight percent of the overall TPU composition.

The TPU compositions described herein may also include additional additives, which may be referred to as a stabilizer. The stabilizers may include antioxidants such as phenolics, phosphites, thioesters, and amines, light stabilizers such as hindered amine light stabilizers and benzothiazole UV absorbers, and other process stabilizers and combinations thereof. In one embodiment, the preferred stabilizer is Irganox 1010 from BASF and Naugard 445 from Chemtura. The stabilizer is used in the amount from about 0.1 weight percent to about 5 weight percent, in another embodiment from about 0.1 weight percent to about 3 weight percent, and in another embodiment from about 0.5 weight percent to about 1.5 weight percent of the TPU composition.

In addition, various conventional inorganic flame retardant components may be employed in the TPU composition. Suitable inorganic flame retardants include any of those known to one skilled in the art, such as metal oxides, metal oxide hydrates, metal carbonates, ammonium phosphate, ammonium polyphosphate, calcium carbonate, antimony oxide, clay, mineral clays including talc, kaolin, wollastonite, nanoclay, montmorillonite clay which is often referred to as nanoclay, and mixtures thereof. In one embodiment, the flame retardant package includes talc. The talc in the flame retardant package promotes properties of high limiting oxygen index (LOI). The inorganic flame retardants may be used in the amount from 0 to about 30 weight percent, from about 0.1 weight percent to about 20 weight percent, in another embodiment about 0.5 weight percent to about 15 weight percent of the total weight of the TPU composition.

Still further optional additives may be used in the TPU compositions described herein. The additives include colorants, antioxidants (including phenolics, phosphites, thioesters, and/or amines), antiozonants, stabilizers, inert fillers, lubricants, inhibitors, hydrolysis stabilizers, light stabilizers, hindered amines light stabilizers, benzotriazole UV absorber, heat stabilizers, stabilizers to prevent discoloration, dyes, pigments, inorganic and organic fillers, reinforcing agents and combinations thereof.

All of the additives described above may be used in an effective amount customary for these substances. The non-flame retardants additives may be used in amounts of from about 0 to about 30 weight percent, in one embodiment from about 0.1 to about 25 weight percent, and in another embodiment about 0.1 to about 20 weight percent of the total weight of the TPU composition.

These additional additives can be incorporated into the components of, or into the reaction mixture for, the preparation of the TPU resin, or after making the TPU resin. In another process, all the materials can be mixed with the TPU resin and then melted or they can be incorporated directly into the melt of the TPU resin.

The TPU materials described above may be prepared by a process that includes the step of (I) reacting: a) the polyisocyanate component described above; b) the polyol component described above; and c) the chain extender component described above, where the reaction is carried out in the presence of a catalyst, and where said catalyst comprises one or more iron (III) compounds, resulting in a thermoplastic polyurethane composition.

The process may further include the step of: (II) mixing the TPU composition of step (I) with one or more blend components, including one or more additional TPU materials and/or polymers, including any of those described above.

The process may further include the step of: (II) mixing the TPU composition of step (I) with one or more of the additional additives described above.

The process may further include the step of: (II) mixing the TPU composition of step (I) with one or more blend components, including one or more additional TPU materials and/or polymers, including any of those described above, and/or the step of: (III) mixing the TPU composition of step (I) with one or more of the additional additives described above.

The TPU materials and/or compositions described herein may be used in the prepared of one or more articles. The specific type of articles that may be made from the TPU materials and/or compositions described herein are not overly limited.

The described technology includes a method of maintaining the ultraviolet stability of a thermoplastic polyurethane composition while reducing the toxicity of the thermoplastic polyurethane compositions. The method involves using one or more iron (III) compounds described herein as a catalyst in place of organotin containing catalysts in the preparation of TPU, including aliphatic TPU, polyether polyol based TPU, and/or aliphatic polyether polyol based TPU.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### Examples

The technology described herein may be better understood with reference to the following non-limiting examples.

The catalytic activity of several tin-free catalysts in a solvent-free reaction between a cycloaliphatic diisocyanate and several alcohols is evaluated. A solvent-free evaluation is used in order to exclude any possible solvent effects that may affect the reactivity of the isocyanate. Methylene-bis-4,4′-(cyclohexylisocyanate) (H12MDI) was purchased under its trade name Desmodur® W from Bayer AG. 1-Butanol, tetrahydrofuran (THF), 1,4-butanediol (BDO) and poly(tetramethylene)glycol (PTMEG-1000; MW 1000 g/mol) were purchased from Sigma-Aldrich. All reactants and solvents were used as received from the respective suppliers. The catalysts were purchased from Sigma-Aldrich and Strem, and were used as received.

### Initial Screening

An initial screening, using 1-butanol, a monofunctional alcohol, is completed to evaluate the activity of several tin-free catalysts at very low concentrations (0.001 mol % of catalyst per mol hydroxyl groups) and mild temperature conditions.

The catalytic activity of the metal compounds A-1 through A-21 are tested in a small-scale solvent-free setup, using an aliphatic diisocyanate(methylene-bis-4,4′-(cyclohexylisocyanate), H12MDI) and a monofunctional alcohol (1-butanol), maintaining an NCO:OH ratio of 1, and the percent conversion for each compound at one or more concentrations is measured.

For this testing, first a stock solution of the catalyst in 1-butanol is prepared by weighing 10-100 mg of catalyst (depending on the molecular weight of the catalyst) in a 12 ml crimp-cap vial, followed by adding 2-5 g of 1-butanol to obtain a mixture with a concentration greater than 0.1 mol % (catalyst per hydroxyl functional group). The catalyst:butanol mixture is stirred and heated gently (<80° C.) if necessary to ensure complete catalyst dissolution. From this stock solution a series of 3 dilutions is prepared (0.1, 0.01 and 0.001 mol % catalyst). Next, a magnetic stirring bar is placed in a 22 ml screw-cap vial after which 1.31 g (5 mmol; 10 mmol NCO functional groups) of H12MDI is added. Subsequently, 0.74 g (10 mmol) of 1-butanol containing the catalyst is added to the H12MDI after which the vial is placed in a heating block at 60° C. After 15 minutes, the vial is taken out of the heating block, placed on ice for 5 minutes to stop the reaction, and 5 ml of tetrahydrofuran (THF) is added to dissolve the formed product. The clear solution is then transferred to a quartz cuvette for near infrared (NIR) analysis. All NIR-spectra are recorded using a Varian Cary® 5000 spectrophotometer. The absorbance at 4650 cm⁻¹ of the sample (A_sample) is used to calculate the conversion, with the absorbance of a blank sample without catalyst (A_uncatalyzed) serving as the 0% benchmark, and the absorbance of a sample containing 0.1 mol % of dibutyl tin dilaurate (A_DBTDL) as a 100% reference. Conversions X are calculated using the following equation:

X=(A_sample−A_uncatalyzed)/(A_DBTDL−A_uncatalyzed)

Thus, the catalyst concentration is provided in mol %, that is moles of catalyst per moles of hydroxyl. The catalysts testing in the initial screening and the conversion results are presented in the table below.

TABLE 1

| | | Percent Conversion, X | | |
|---|---|---|---|---|
| Ex | | catalyst concentration | | |
| No | Catalyst | at 0.1 | at 0.01 | at 0.001 |
| A-1 | dibutyl tin dilaurate (DBTDL) | 100 | 96 | 32 |
| A-2 | Sn(octoate)₂ | 99 | 28 | — |
| A-3 | bis(dodecylthio) dimethyl tin | 100 | 99 | 50 |
| A-4 | Mn(acetylacetonate)₂ | 96 | 93 | 73 |
| A-5 | Fe(acetylacetonate)₃ | 95 | 94 | 90 |
| A-6 | Fe(2,2,6,6-tetramethyl-3,5- | 100 | 100 | 98 |
| | heptanedionate)₃ | | | |
| A-7 | FeCl₃ | 91 | 90 | 14 |
| A-8 | Ru(acetylacetonate)₃ | 5 | — | — |
| A-9 | Ti(isopropoxide)₂(acetylacetonate)₂ | 91 | 81 | 69 |
| A-10 | Zr(acetylacetonate)₄ | 95 | 92 | 68 |
| A-11 | Hf(acetylacetonate)₄ | 100 | 96 | 82 |
| A-12 | Al(acetylacetonate)₃ | 2 | — | — |
| A-13 | Ga(2,2,6,6-tetramethyl-3,5- | 100 | 100 | 51 |
| | heptanedionate)₃ | | | |
| A-14 | In(acetylacetonate)₃ | 93 | 40 | — |
| A-15 | Zn(acetylacetonate)₂ | 98 | 39 | — |
| A-16 | Zn(2,2,6,6-tetramethyl-3,5- | 99 | 95 | 68 |
| | heptanedionate)₂ | | | |
| A-17 | ZnCl₂ | 53 | — | — |
| A-18 | Zn(trifluoromethanesulfonate)₂ | 67 | 13 | — |
| A-19 | Sc(trifluoromethanesulfonate)₃ | 37 | — | — |
| A-20 | La(trifluoromethanesulfonate)₃ | 41 | — | — |
| A-21 | Fe(trifluoromethanesulfonate)₃ | 84 | 28 | — |

Examples A-1 to A-3 are tin containing comparative examples. Examples A-4, and A-8 to A-20 are tin-free comparative examples. Examples A-5, A-6, A-7, and A-21 are inventive examples prepared with iron (III) compounds as the catalysts. The data shows that the inventive examples show very good catalytic activity, in some instances even better than the tin containing catalyst comparative examples, and generally better than all of the other tin-free comparative examples tested.

### Catalyst Activity in Polymer System

Based on this screening a selection of the best candidate catalysts is then subjected to additional testing in a more realistic polymeric system, using a mixture of diols and diisocyanate at autogenous temperature.

In this next testing stage, a mixture of poly(tetramethylene ether)glycol (molecular weight 1,000 g·mol⁻¹; PTMEG-1000) and 1,4-butanediol is used where 1,4-butanediol accounts for 55.3% of the hydroxyl groups with sequential addition of the 1,4-butanediol and catalyst at 80° C. and H12MDI at 80° C. under constant stirring (400 rpm). The reaction is monitored by following the temperature of the mixture as the exothermic polymerization progresses.

Prior to the actual polymerization, a catalyst stock solution is prepared by dissolving 5-20 mg catalyst in 5-10 g of 1,4-butanediol (BDO). This stock solution is subsequently diluted with BDO until the desired concentration is obtained. Next, 2.84 g of this diluted catalyst-in-BDO solution is weighed in a crimp cap vial, after which the vial is capped and placed in a heating block at 80.0±0.5° C. Next, 14.32 g of H12MDI is weighed in a 22 ml screw cap vial, after which the vial is closed and placed in the same heating block at 80° C. 23.76 g of 1000 molecular weight PTMEG-1000 is weighed in a tin can, which served as an open reactor, and heated to 120° C., while being stirred continuously at 400 rpm using an IKA Eurostar power control-visc overhead stirrer equipped with a 3-blade 45 mm diameter stainless steel R1381 propeller stirrer. As soon as the PTMEG-1000 reaches a temperature of 120° C., the heated BDO/catalyst solution is added to the reactor by pouring from the vial; immediately after adding the BDO/catalyst solution, the heated H12MDI is added to the reactor by emptying the vial. The temperature change of the reaction is then monitored in situ by a Testo temperature probe connected to a laptop on which the Comfort Software X35 has been installed. After 3 minutes of reaction the stirrer is turned off and the reaction mixture is poured out onto a cooled Teflon plate. The final monomer composition was 53.1 mmol H12MDI, 29.3 mmol BDO and 23.8 mmol PTMEG-1000, with relative errors on the quantities below 0.5%. The highly reproducible nature of the procedure was confirmed by repetitions of a standard procedure using 0.001 mol % DBTDL.

As TPU is produced industrially in an extrusion process, the homogeneous catalyst is not separated or recycled from the solid polymer. For these reasons, it is a prerequisite that the catalyst is highly active at very low concentrations. In order to evaluate the catalytic activity at such low concentrations, additional dilutions of the catalyst solution were prepared and tested per the standard protocol. As expected, the generated reaction heat becomes less pronounced for lower catalyst concentrations.

The table below lists approximate peak temperatures autogenously reached for each catalyst tested, and how fast the peak temperature was reached (using the time of isocyanate addition as the starting point) at each concentration the catalyst was tested at. The higher the peak temperature and the faster the system reached the peak, the more active the catalyst.

TABLE 2

| | | Approx | Time |
|---|---|---|---|
| Ex | | Peak Temp | to Peak |
| No | Catalyst and concentration | (° C.) | (sec) |
| B-1 | dibutyl tin dilaurate at 0.1 mol % | 189 | 22 |
| B-2 | dibutyl tin dilaurate at 0.01 mol % | 171 | 93 |
| B-3 | dibutyl tin dilaurate at 0.001 mol % | 110 | 65 |
| B-4 | Fe(acetylacetonate)₃ at 0.1 mol % | 192 | 19 |
| B-5 | Fe(acetylacetonate)₃ at 0.01 mol % | 187 | 23 |
| B-6 | Fe(acetylacetonate)₃ at 0.002 mol % | 181 | 21 |
| B-7 | Fe(acetylacetonate)₃ at 0.001 mol % | 172 | 50 |
| B-8 | Fe(acetylacetonate)₃ at 0.0005 mol % | 161 | 67 |
| B-9 | Fe(acetylacetonate)₃ at 0.00025 mol % | 144 | 141 |

The results show that the comparative examples B-1 to B-3, which use DBTDL, are much less active at lower concentrations than the inventive examples B-4 to B-9, which use Fe(acetylacetonate)₃. When lowering the catalyst concentration to 0.001 mol % the difference between DBTDL and Fe(acetylacetonate)₃ becomes more pronounced. While DBTDL seems to lose most of its catalytic activity, Fe(acetylacetonate)₃ remains highly active. Even at extremely low concentrations of 0.00025 mol %, polymerization takes place, albeit to a clearly smaller extent as the reaction mixture remains liquid after 5 minutes.

While not wishing to be bound by theory, a possible explanation for this remarkable difference in activity may be that DBTDL is much more susceptible to hydrolysis than iron (III) compounds, like Fe(acetylacetonate)₃. Trace amounts (up to 100 ppm) of water may be present in the 1,4-butanediol, which is also the case in a typical industrial production environment, and so increased susceptibility to hydrolysis may inhibit DBTDL, whereas iron (III) compounds, like Fe(acetylacetonate)₃, are more resistant to hydrolysis and so can provide better performance in industrial settings.

A similar test is completed with a wider set of catalysts all evaluated at 0.001 mol %, using the same reaction mixture and conditions described above except that this reaction uses 1,4-butanediol alone. The table below lists approximate peak temperatures and how fast the peak temperature was reached (using the time of isocyanate addition as the starting point) at each concentration the catalyst was tested at.

TABLE 3

| | | Approx | Time |
|---|---|---|---|
| Ex | | Peak Temp | to Peak |
| No | Catalyst, all at 0.001 mol % | (° C.) | (sec) |
| C-1 | dibutyl tin dilaurate | 110 | 65 |
| C-2 | bis(dodecylthio) dimethyl tin | 173 | 93 |
| C-3 | Mn(acetylacetonate)₂ | 120 | >150 |
| C-4 | Hf(acetylacetonate)₄ | 112 | 137 |
| C-5 | Zr(acetylacetonate)₄ | No Peak | No Peak |
| C-6 | Fe(acetylacetonate)₃ | 172 | 50 |
| C-7 | Fe(Cl)₃ | 173 | 57 |

The results here show the iron compound catalysts have much better activity than the catalysts used in the comparative examples, including catalysts with similar ligands but not based on iron.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A thermoplastic polyurethane composition comprising the reaction product of:
a) a polyisocyanate;
b) a polyol component; and
c) a chain extender component;
wherein the reaction is carried out in the presence of a catalyst;
wherein said catalyst comprises one or more iron compounds.

2. The thermoplastic polyurethane composition of claim 1 wherein the catalyst is free of tin.

3. The thermoplastic polyurethane composition of claim 1 wherein the catalyst comprises a compound having the general structure (X)ₘ-M-(Y)ₙ where m is 2 or 3, M is iron; each X is independently a ligand with a −1 charge, obtained by deprotonation of a β-diketone compound, a β-ketoester compound, a β-ketoamide compound or any other β-dicarbonyl compound, chloride, bromide, iodide, fluoride, perchlorate, alkoxide, alkylsulfonate, arylsulfonate, alkylsulfate, arylsulfate, hydroxide, or a combination of these ligands; each Y is a neutral ligand; and n is an integer between 0 and 6.

4. The thermoplastic polyurethane composition of claim 1 wherein the catalyst comprises a compound of Fe(III) or Fe(II) containing three or two anionic ligands, each formed by deprotonation of a β-diketone, a β-ketoester, a β-ketoamide, or a combination thereof.

5. The thermoplastic polyurethane composition of claim 1 wherein the catalyst comprises a compound of Fe(III) or Fe(II) containing three or two halide counteranions each derived from chloride, fluoride, bromide, iodide, a compound resulting from the partial alcoholysis or hydrolysis of any of these compounds, or a combination thereof.

6. The thermoplastic polyurethane composition of claim 1 wherein the catalyst comprises a compound of Fe(III) or Fe(II) containing one, two or three α-diimine ligands each derived from 2,2′-bipyridine, 1,10-phenanthroline, substituted variants of 2,2′-bipyridine or 1,10-phenanthroline, or some combination thereof.

7. The thermoplastic polyurethane composition of claim 1 wherein the catalyst comprises iron(III)-tris-2,4-pentanedionate, iron(III)-tris-(1,1,1-trifluoro-2,4-pentanedionate), iron(III)-tris-(1,1,1,5,5,5-hexafluoro-2,4-pentanedionate), iron (III)-tris-(2,2,6,6-tetramethyl-3,5-heptanedionate), iron(III)-tris-(6-methyl-2,4-heptanedionate); iron (III) chloride, iron(II)chloride, iron(III)bromide; iron(III)-tris(2,2′-bipyridine) trichloride, iron(III)-tris(1,10-phenanthroline) trichloride, or combinations thereof.

8. The thermoplastic polyurethane composition of claim 1 wherein the polyisocyanate comprises an aromatic diisocyanate, an aliphatic diisocyanate, or a combination thereof.

9. The thermoplastic polyurethane composition of claim 1 wherein the polyisocyanate is at least 50%, on a weight basis, a cycloaliphatic diisocyanate.

10. The thermoplastic polyurethane composition of claim 1 wherein the polyol component comprises a polyether polyol.

11. The thermoplastic polyurethane composition of claim 1 wherein the chain extender component comprises diols, diamines, or combinations thereof.

12. The thermoplastic polyurethane composition of claim 1 wherein the polyisocyanate comprises 4,4′-methylene bis(cyclohexylisocyanate);
wherein the polyol component comprises poly(tetramethylene ether glycol);
wherein the chain extender component comprises 1,4-butanediol; and
wherein the catalyst comprises iron (III) chloride.

13. A process of preparing a thermoplastic polyurethane composition comprising the step of:
(I) reacting:
a) a polyisocyanate;
b) a polyol component; and
c) a chain extender component;
wherein the reaction is carried out in the presence of a catalyst;
wherein said catalyst comprises one or more iron (III) compounds;
resulting in a thermoplastic polyurethane composition.

14. An article comprising the thermoplastic polyurethane composition of claim 1.

15. A method of maintaining the ultraviolet stability of a thermoplastic polyurethane composition while reducing the toxicity of the thermoplastic polyurethane composition, comprising the steps of:
(I) reacting:
a) a polyisocyanate;
b) a polyol component; and
c) a chain extender component;
wherein the reaction is carried out in the presence of a catalyst;
wherein said catalyst comprises one or more iron (III) compounds;
resulting in a thermoplastic polyurethane composition with ultraviolet stability and reduced toxicity compared to a similar thermoplastic polyurethane composition made using a tin containing catalyst
